(19) United States
(12) Patent Application Publication
(10) Pub. No.: US 2021/0370577 A1
(43) Pub. Date: Dec. 2, 2021

(54) METHOD OF MANUFACTURING HIGH-PRESSURE TANK

(71) Applicant: TOYOTA JIDOSHA KABUSHIKI KAISHA, Toyota-shi (JP)

(72) Inventor: Ken HATTA, Toyota-shi (JP)

(73) Assignee: TOYOTA JIDOSHA KABUSHIKI KAISHA, Toyota-shi (JP)

(21) Appl. No.: 17/224,182

(22) Filed: Apr. 7, 2021

(30) Foreign Application Priority Data
Jun. 2, 2020 (JP) 2020-095920

(51) Int. Cl. B29C 53/56; B29C 63/24

(52) U.S. Cl. CPC B29C 53/56; B29L 2031/7172; B29C 63/24

(57) ABSTRACT

A method of manufacturing a high-pressure tank includes forming a winding layer on an outer periphery of a liner, to prepare a preform, placing the preform in a mold, and supplying a resin composition to the winding layer, and formation of the winding layer includes winding of a tow prepreg, and winding of a fiber bundle.

### CROSS-REFERENCE TO RELATED APPLICATION

This application claims priority to Japanese Patent Application No. 2020-095920 filed on Jun. 2, 2020, incorporated herein by reference in its entirety.

### BACKGROUND

### 1. Technical Field

The disclosure relates to a high-pressure tank that is reinforced by a fiber layer impregnated with resin.

### 2. Description of Related Art

A high-pressure tank for a fuel cell vehicle has a liner that forms the interior space of the high-pressure tank, and a reinforcement layer formed by providing a fiber layer impregnated with resin, on the outer periphery of the liner. The high-pressure tank thus constructed achieves high strength.

According to a method of manufacturing fiber-reinforced plastics as disclosed in Japanese Unexamined Patent Application Publication No. 2008-132717 (JP 2008-132717 A), a core made of metal is covered with fibers or a sheet-like fiber product, and then the fibers or sheet-like fiber product covering the core is impregnated with matrix resin, or a core is covered with fibers or a sheet-like fiber product impregnated with matrix resin. Thereafter, the matrix resin is heated and precured, and then heated for after-curing at a temperature higher than the temperature at which the matrix resin was precured. This method is characterized in that the metal core is formed of a metal having a melting point that is higher than the heating temperature at which the resin is precured, and is lower than the heating temperature at which the resin is after-cured.

A method of manufacturing a high-pressure tank as disclosed in Japanese Unexamined Patent Application Publication No. 2011-000811 (JP 2011-000811 A) has a process of forming a pre-FRP (fiber-reinforced plastic) layer by winding fibers impregnated with a base compound on a substrate, using a filament winding method, and a process of injecting a curing agent into the pre-FRP layer under a pressurized condition, and causing the base compound of the pre-FRP layer to react with the curing agent, to form a FRP layer including thermosetting resin and fibers on the substrate. In the process of forming the FRP layer, a curing agent having a low curing start temperature is injected, and then, a curing agent having a high curing start temperature is injected, so that the base compound of the pre-FRP layer reacts with the curing agent having the low curing start temperature and the curing agent having the high curing start temperature, to form the FRP layer including the thermosetting resin and the fibers, on the substrate.

A method of producing a composite container as disclosed in Japanese Unexamined Patent Application Publication No. 2010-221401 (JP 2010-221401 A) includes a process of forming a fiber layer by winding fibers preliminarily impregnated with thermosetting resin, on a liner, a process of heating the liner from the inside thereof, so as to reduce the viscosity of the resin in the fibers wound on the liner, to be lower than the viscosity before winding on the liner, and a process of heating the liner from the inside thereof, after reducing the viscosity, so that the resin in the fiber layer is gradually cured from the side closer to the surface of the liner, to the side remote from the liner surface.

A method of manufacturing a high-pressure tank as disclosed in Japanese Unexamined Patent Application Publication No. 2008-286297 (JP 2008-286297 A) includes a step of winding a first fiber-reinforced composite material including first fiber bundles consisting of a plurality of fibers, and thermosetting resin provided between the fibers in an uncured state, on the outer periphery of a hollow liner, to form a laminate of first fiber-reinforced composite layers, a step of winding a second fiber-reinforced composite material including second fiber bundles consisting of a plurality of fibers, and thermosetting resin provided between the fibers in an uncured state, on the outer periphery of the first fiber-reinforced composite layers, to form a laminate of second fiber-reinforced composite layers, and a step of curing the thermosetting resin by heating, after forming the laminates of the first fiber-reinforced composite layers and second fiber-reinforced composite layers. This manufacturing method is characterized in that, during winding, the viscosity of the thermosetting resin provided in the first fiber-reinforced composite material is set to be higher than the viscosity of the thermosetting resin provided in the second fiber-reinforced composite material.

According to a method of manufacturing a high-pressure tank as disclosed in Japanese Unexamined Patent Application Publication No. 2019-056415 (JP 2019-056415 A), a preform having a liner that forms the interior space of a high-pressure tank, and a fiber layer provided on an outer surface of the liner, is placed in a metal mold, and the preform is rotated in a circumferential direction about its central axis in the mold while resin is injected toward the preform placed in the mold, so that the fiber layer is impregnated with the resin.

### SUMMARY

In so-called resin transfer molding (RTM), a fiber layer of a preform (a member having a fiber layer formed on a liner) is impregnated with a resin composition, which is then cured, to form a reinforcement layer. In this molding, it may be difficult to uniformly impregnate the fiber layer with the resin, depending on the thickness or shape of the fiber layer. In the case of a high-pressure tank for a fuel cell vehicle, in particular, the fiber layer has an increased thickness so as to ensure sufficient strength, and has a cylindrical shape that is elongate in the axial direction; thus, the above problem is more significantly recognized.

In the above situation, if the resin is injected into the fiber layer under a high pressure, the liner, etc. may be deformed due to the pressure, or large-scale equipment may be required. On the other hand, if impregnation is performed in a state where the resin has a high fluidity, it takes time to cure the resin, resulting in reduction of the productivity.

Also, if a reinforcement layer is formed by winding fibers including resin in advance, around a liner, and then heating the fibers, to cause the resin to flow, the winding state of the resin may be changed due to the flow of the resin included in the fibers, which may cause a problem in the density or homogeneity of the winding.

This disclosure provides a method of manufacturing a high-quality, high-pressure tank, while enhancing the capability of impregnating a fiber layer with resin, and curbing reduction of the productivity.

A method of manufacturing a high-pressure tank according to this disclosure includes forming a winding layer on an outer periphery of a liner, to prepare a preform, and placing the preform in a mold, and supplying a resin composition to the winding layer. In this method, formation of the winding layer includes winding of a tow prepreg, and winding of a fiber bundle.

The winding layer may be formed by winding the tow prepreg, and then winding the fiber bundle on an outer periphery of the tow prepreg. Instead, the winding layer may also be formed, such that at least one of layers that constitute the winding layer is Ruined by winding a mixture of the tow prepreg and the fiber bundle.

The resin composition may start being supplied, after the viscosity of resin contained in the tow prepreg is reduced to be lower than that of the resin during winding.

A curing agent that cures a resin contained in the tow prepreg at a temperature lower than a temperature of the mold may be added to the resin.

The winding of the tow prepreg and winding of the fiber bundle may be performed with a multi-supply filament winding device, or a continuous multi-supply filament winding apparatus.

According to this disclosure, it is possible to manufacture a high-quality, high-pressure tank, while enhancing the capability of impregnating the winding layer with resin, and curbing reduction of the productivity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing the exterior appearance of a high-pressure tank;

FIG. 2 is a view schematically showing a cross section of the high-pressure tank of FIG. 1;

FIG. 3 is a view schematically showing a cross section of a preform;

FIG. 4 is an enlarged view of a part of FIG. 3;

FIG. 5 is a view useful for describing a TPP (tow prepreg) layer;

FIG. 6 is a view useful for describing a fiber layer;

FIG. 7 is a view illustrating the flow of a method of manufacturing the high-pressure tank;

FIG. 8 is a view useful for describing a step of forming the TPP layer;

FIG. 9 is a view useful for describing a step of forming the fiber layer;

FIG. 10 is a view useful for describing a mold;

FIG. 11 is a view useful for describing the mold;

FIG. 12 is a view useful for describing a step of supplying and stopping a resin composition;

FIG. 13 is a view showing an example of the relationship between time and temperature of resin contained in TPP;

FIG. 14 is a view useful for describing a winding layer according to another embodiment;

FIG. 15 is a view useful for describing the manner of winding TPP and fiber bundles according to another embodiment;

FIG. 16 is a view useful for describing a method of winding in the embodiment of FIG. 15; and

FIG. 17 is a view useful for describing another method of manufacturing a high-pressure tank.

### DETAILED DESCRIPTION OF EMBODIMENTS

### 1. Structure of High-Pressure Tank

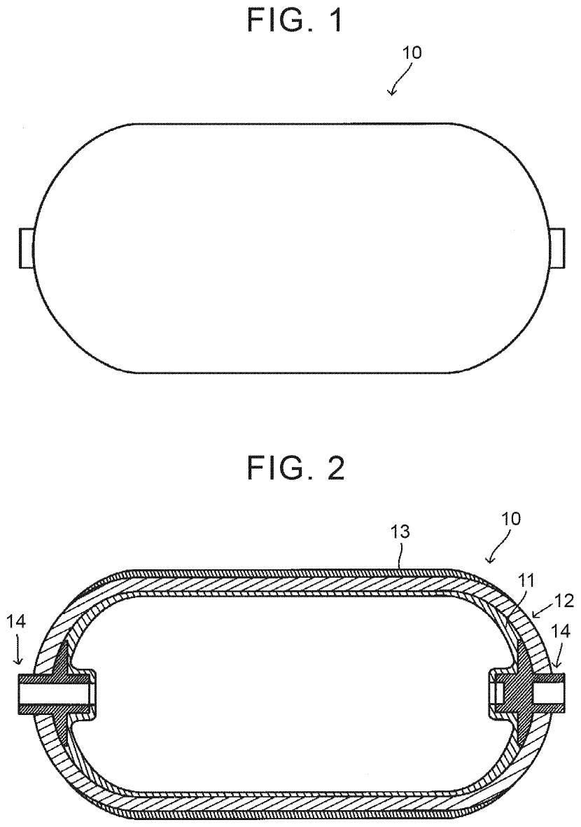

FIG. 1 schematically shows the exterior appearance of a high-pressure tank 10 according to one embodiment, and FIG. 2 schematically shows a cross section of the high-pressure tank 10 taken along the axis thereof. As is understood from these figures, the high-pressure tank 10 of this embodiment has a liner 11, reinforcement layer 12, protection layer 13, and caps 14. Each of the components will be described below.

The liner 11 is a hollow member that defines interior space of the high-pressure tank 10. The liner 11 may be formed of any known material, provided that the material can hold a substance (such as hydrogen) contained in the interior space, without leaking it. For example, the liner 11 is formed of nylon resin, polyethene synthetic resin, or metal, such as stainless steel, or aluminum. The thickness of the liner 11 is not particularly limited, but is preferably in the range of 0.5 mm to 1.0 mm.

The reinforcement layer 12 is a laminate consisting of a plurality of fiber layers, and has resin that impregnates the fibers and is cured. The fiber layers are formed by winding fiber bundles around an outer surface of the liner 11, to provide any number of layers corresponding to a predetermined thickness. The thickness of the reinforcement layer 12 is about 10 mm to 30 mm, though it is not particularly limited since it is determined depending on the required strength. In the case where the high-pressure tank is used for a fuel cell vehicle, in particular, the reinforcement layer needs to be formed with a large thickness, so as to ensure sufficient strength, which makes it highly difficult to impregnate the fiber layer having the large thickness with resin. One half of the reinforcement layer 12 (and a winding layer 21 that will be described later) in terms of the thickness, which is closer to the liner 11, may be referred to as “inner layer side”, and the other half of the reinforcement layer 12 remote from (or on the radially outer side of) the liner 11 may be referred to as “outer layer side”.

Carbon fibers are used for the fiber bundles of the reinforcement layer 12, and each fiber bundle, which is a bundle of carbon fibers, is in the form of a belt having a given cross-sectional shape (e.g., a rectangular cross section). More specifically, the cross-sectional shape, though it is not particular limited, is a rectangle having a width of about 6 mm to 10 mm, and a thickness of about 0.1 mm to 0.15 mm. While the amount of carbon fibers included in the fiber bundle is also not particularly limited, the fiber bundle may consist of about 36000 carbon fibers.

The resin that impregnates the fibers and is cured in the reinforcement layer 12 is not particularly limited, provided that it can increase the strength of the fibers. For example, the resin may be selected from thermosetting resins that are cured by heat, such as epoxy resin, unsaturated polyester resin, etc. including an amine-based or anhydride curing accelerator, and a rubber-based reinforcing agent. The resin may also be selected from resin compositions having epoxy resin as a base compound, with which a curing agent is mixed for curing of the base compound. While the base compound is mixed with the curing agent and cured, the resin composition as the mixture of the base compound and the curing agent is caused to reach the fiber layers and penetrate through them, so that the resin is automatically cured.

The protection layer 13 is placed on the outer periphery of the reinforcement layer 12 as needed. When the protection layer 13 is provided, glass fibers are wound around the reinforcement layer 12, and are impregnated with resin. The resin impregnating the glass fibers may be selected in the same way as the reinforcement layer 12. The protection layer 13 can give impact resistance to the high-pressure tank 10. The thickness of the protection layer 13 is not particularly limited, but may be about 1.0 mm to 2.0 mm.

The caps 14 are respectively attached to two opening ends of the liner 11, and one of the caps 14 functions as an opening that communicates the interior of the high-pressure tank 10 with the exterior, and also functions as a mounting part for mounting a pipe or valve to the high-pressure tank 10. Also, the caps 14 function as mounting parts for mounting the liner 11 on a multi-supply filament winding device that will be described later, when the reinforcement layer 12 is formed. Where the liner 11 is formed of metal, there is no need to separately provide caps, but parts shaped like the caps may be formed continuously with the liner 11.

### 2. Structure of Preform

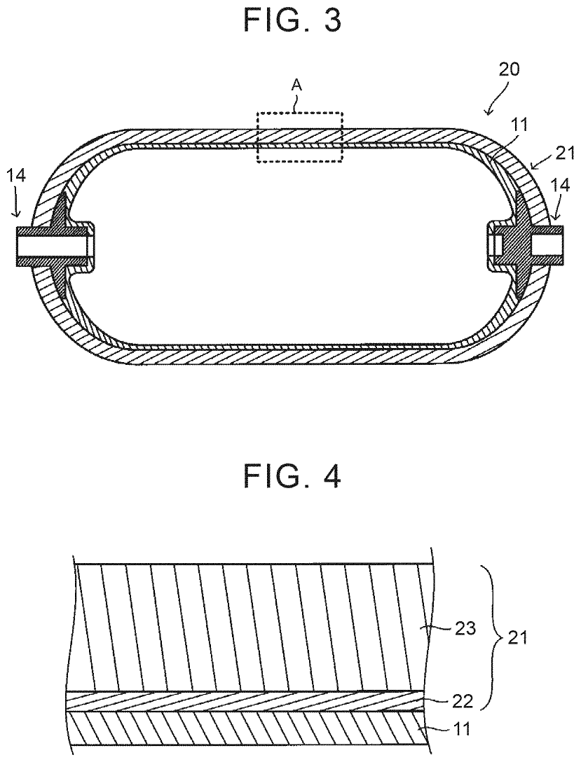

A preform 20 is an intermediate member that eventually provides the high-pressure tank 10, and has at least the liner 11 and a winding layer 21. Namely, the preform 20 is a member in which the winding layer 21 (or a fiber layer 23 included in the winding layer 21) has not been impregnated with resin. FIG. 3 shows a cross section of the preform 20, and FIG. 4 is an enlarged view of a portion labeled “A” in FIG. 3, which is useful for describing the layer arrangement. In this embodiment, the preform 20 has the liner 11, winding layer 21, and caps 14. The liner 11 and the caps 14 have been described above, and will not be described herein. The winding layer 21 will be described. While the preform 20 is configured such that the winding layer 21 is placed on the liner 11 in this embodiment, glass fibers that provide the protection layer 13 may be further wound on the outer periphery of the winding layer 21.

The winding layer 21 is supplied with and impregnated with a resin composition, which is then cured, as described later, to provide the reinforcement layer 12 of the high-pressure tank 10. In this embodiment, the winding layer 21 includes a TPP layer 22 and a fiber layer 23, as shown in FIG. 4.

The TPP layer 22 is formed by winding fiber bundles (tow prepreg, which will be denoted as “TPP”) impregnated in advance with resin that is in a partially cured state. The fiber bundle that provides the TPP is not particularly limited, but may be considered as the same fiber bundle as the one described above, and may be in the form of a belt as a bundle of carbon fibers, which has a given cross-sectional shape (e.g., a rectangular cross section).

The resin contained in the TPP is not particularly limited, but is preferably of the same type as the resin with which the fiber layer 23 is impregnated as will be described later. In this case, the resin of the TPP is likely to be integrated with the resin impregnating the fiber layer 23, which makes it less likely or unlikely to cause a problem in terms of homogeneity or peel-off. Thus, the resin contained in the TPP may be selected from thermosetting resins that are cured by heat, such as epoxy resin, unsaturated polyester resin, etc. including an amine-based or anhydride curing accelerator, and a rubber-based reinforcing agent. The resin may also be selected from resin compositions having epoxy resin as a base compound, with which a curing agent is mixed for curing of the base compound. Also, a low-temperature curing agent may be added to the resin contained in the TPP layer. The low-temperature curing agent starts curing the resin at a relatively low temperature (specifically, a temperature lower than the temperature of a mold 40), and provides high reactivity. High-temperature heat generated at this time can be used for heating the resin composition supplied, from the inner layer side, thus achieving both high-speed impregnation and high-speed curing. The low-temperature curing agent is not limited to any particular agent, but may be selected from, for example, xylenediamide, diethylene triamine, and triethylenetetramine.

In this embodiment, the TPP layer 22 is placed (wound) on the inner layer side of the winding layer 21. Thus, even when the thickness of the winding layer 21 needs to be increased so as to increase the thickness of the reinforcement layer 12, the resin included on the inner layer side can be supplemented by the resin of the TPP, and the winding layer 21 can ensure homogenous resin distribution, and high performance as the reinforcement layer. Also, since the resin is placed in advance in a portion that is hard to be impregnated with resin, the fiber layer 23 can be promptly impregnated with resin, and efficient impregnation can be achieved, namely, the productivity of the high-pressure tank can be improved. The TPP layer 22 on the inner layer side preferably includes at least the innermost layer that contacts with the liner 11, and only the one layer that contacts with the liner 11 may be provided by the TPP layer.

The fiber layer 23 consists of layers other than the TPP layer 22, in the winding layer 21, and the layers are formed by winding fiber bundles that are not impregnated with resin. Thus, in this embodiment, the fiber layer 23 is placed (wound) on the radially outer side of the TPP layer 22. Preferably, one layer that contact with the liner 11, or two or more layers laminated on the liner 11, on the inner layer side, provide the TPP layer 22, and the outer side of the TPP layer 22 provides the fiber layer 23, as shown in FIG. 4. The fiber bundle that constitutes the fiber layer 23 may be considered as the same as the fiber bundle as described above, and may be in the form of a belt as a bundle of carbon fibers, which has a given cross-sectional shape (e.g., a rectangular cross section).

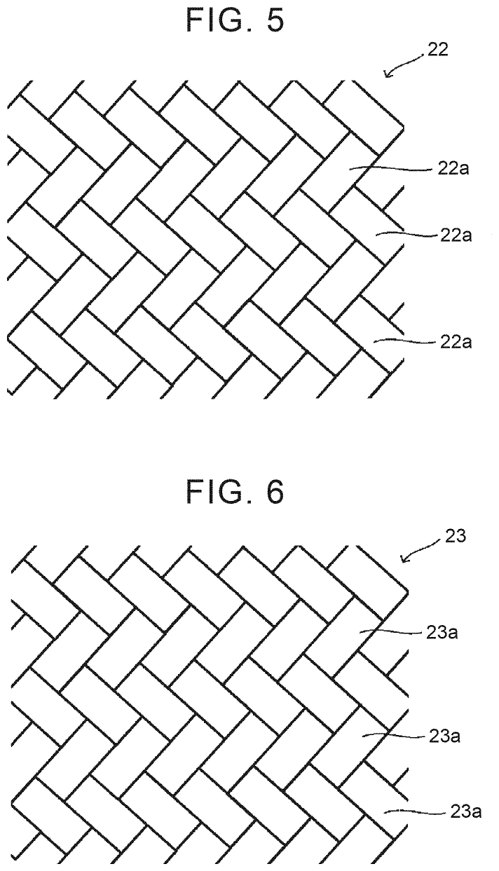

In this embodiment, the TPP layer 22 and the fiber layer 23 are formed by helically winding TPP 22a and fiber bundles 23a as shown in FIG. 5 and FIG. 6, respectively. FIG. 5 is an enlarged view of the exterior appearance of the TPP layer 22, and FIG. 6 is an enlarged view of the exterior appearance of the fiber layer 23. In this manner, the TPP and the fiber bundles can be quickly wound, and slight clearances are formed between adjacent ones of the TPP and between adjacent ones of the fiber bundles, so as to facilitate impregnation of resin. However, the manner of winding is not limited to helical winding, but the TPP layer may be subjected to hoop winding, for example, so as to provide high tightening force, and high adhesiveness between adjacent ones of the TPP, while the fiber layer 23 may be subjected to helical winding, so that it can be easily impregnated with the resin composition.

### 3. Manufacturing Method 1

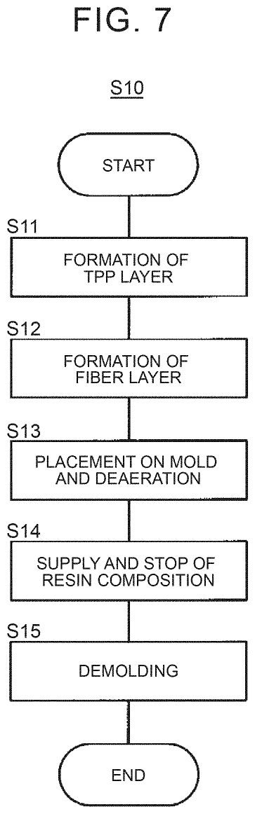

FIG. 7 illustrates the flow of a method S10 of manufacturing a high-pressure tank according to one embodiment. As is understood from FIG. 7, the method S10 of manufacturing the high-pressure tank includes step S11 of forming the TPP layer, step S12 of forming the fiber layer, step S13 of placing the preform in a mold and deaerating the mold, step S14 of supplying and stopping the resin composition, and step S15 of releasing the preform from the mold. The winding layer is formed through step S11 of forming the TPP layer and step S12 of forming the fiber layer, whereby the preform 20 is prepared. Each of the above steps will be described.

Step S11 of Forming the TPP Layer

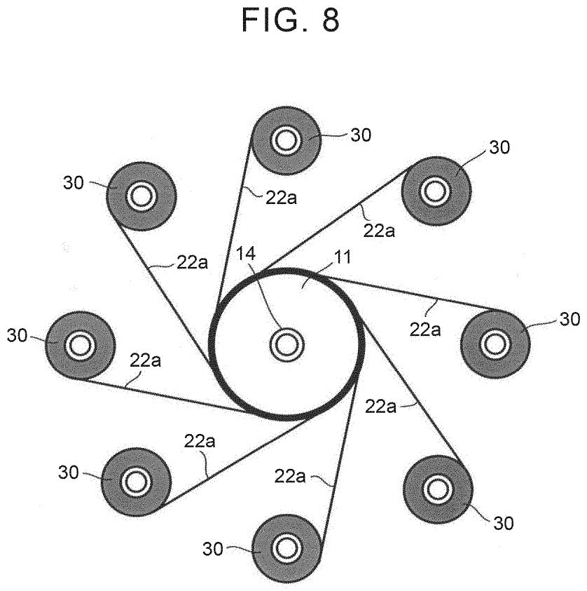

In step S11 of forming the TPP layer (which may be referred to as “step S11”), the TPP 22a is wound on the outer periphery of the liner 11. FIG. 8 schematically shows a scene where the TPP layer 22 is formed by winding the TPP 22a.

In step S11, the TPP 22a is wound around the liner 11, to form the TPP layer 22. Namely, in this embodiment, one layer that contacts with the liner 11, or two or more layer wound outside the one layer, is/are formed of the TPP 22a, to provide the TPP layer 22.

In this embodiment, the winding of the TPP 22a is conducted by a filament winding method, as is understood from FIG. 8. In this embodiment, one multi-supply filament winding device (which may be referred to as “multi-supply FW device”) is used in which a plurality of TPP bobbins 30 as bobbins on which the TPP 22a is wound is arranged along the outer periphery of the liner 11, so as to surround the liner 11.

More specifically, in the multi-supply FW device in which a plurality of bobbins can be installed around the liner 11, all of the bobbins are used as the TPP bobbins 30 in step S11. Then, the TPP 22a is reeled out from the TPP bobbins 30, and wound around the outer periphery of the liner 11. Then, the winding of the TPP 22a is performed until a desired TPP layer 22 is formed.

The number of the bobbins that can be installed at the same time in the multi-supply FW device is not particularly limited, but 48 bobbins, for example, may be installed. In this case, when the TPP layer 22 is formed, all of the 48 bobbins may serve as the TPP bobbins 30.

Step S12 of Forming Fiber Layer

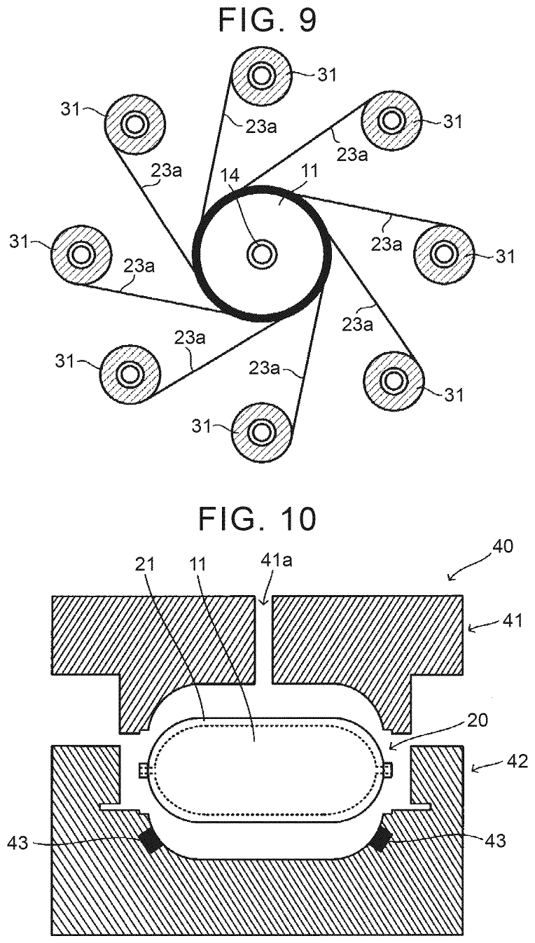

In step S12 of forming the fiber layer (which may be referred to as “step S12”), the fiber bundles 23a are wound on the outer periphery of the TPP layer 22 formed in step S11. FIG. 9 schematically shows a scene in which the fiber layer 23 is formed through winding of the fiber bundles 23a.

In step S12, the fiber bundles 23a are wound on the outer periphery of the TPP layer 22, to form the fiber layer 23. Namely, in step S12 of this embodiment, a plurality of layers is formed from the fiber bundles 23a wound on the outer periphery of the TPP layer 22, to provide the fiber layer 23.

The lamination of the fiber bundles 23a as described above is carried out by a filament winding method in this embodiment, as is understood from FIG. 9. In this embodiment, one multi-supply FW device is used in which a plurality of fiber-bundle bobbins 31 as bobbins on which the fiber bundles 23a are wound is arranged along the outer periphery of the liner 11, so as to surround the liner 11. The multi-supply FW device used in step S11 may be used as the multi-supply FW device in this step.

More specifically, in the multi-supply FW device in which a plurality of bobbins can be installed around the liner 11, all of the bobbins are used as the fiber-bundle bobbins 31 in step S12. Then, the fiber bundles 23a are reeled out from the fiber-bundle bobbins 31, and wound on the outer periphery of the TPP layer 22 that is wound around the liner 11. Then, the winding of the fiber bundles 23a is conducted until they form the fiber layer 23. When the multi-supply FW device used in step S12 is the same as the multi-supply FW device used in step S11, the TPP bobbins 30 may be replaced with the fiber-bundle bobbins 31.

Then, step S12 is combined with step S11 to provide a step of forming the winding layer, so that the preform 20 is prepared. Also, glass fibers for the protection layer 13 may be further wound as needed.

Step S13 of Placing Preform in Mold and Deaerating Mold

In step S13 of placing the preform in the mold and deaerating the mold (which may be referred to as “step S13”), the preform 20 prepared in step S12 is placed in the mold, and the air is evacuated from the mold by vacuuming. With the mold thus deaerated, the resin composition used for impregnation is more likely to permeate the winding layer 21 (mainly, the fiber layer 23), and the winding layer 21 (or fiber layer 23) is more smoothly impregnated with the resin composition.

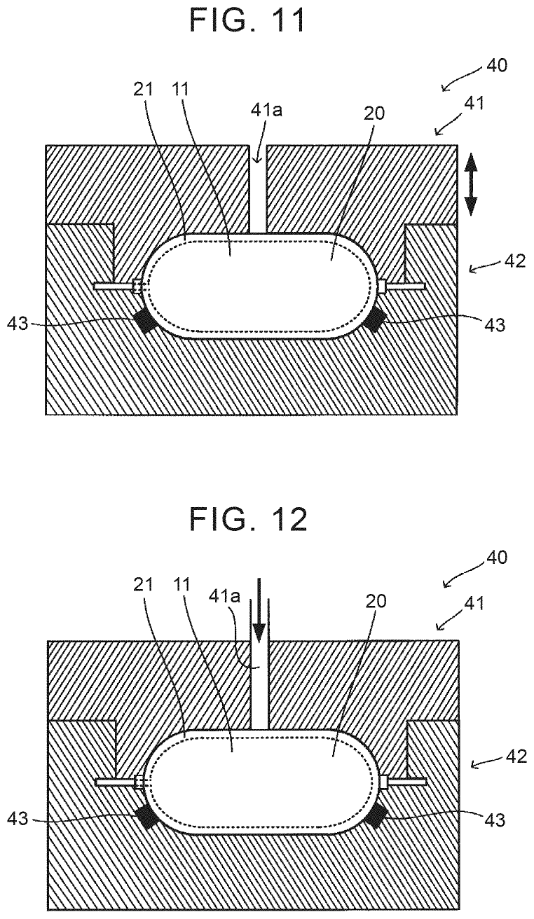

FIG. 10 and FIG. 11 are useful for describing a mold 40 as one example. FIG. 10 is a schematic, exploded cross-sectional view of the mold 40 shown along with the preform 20, and FIG. 11 is a schematic cross-sectional view of the mold 40 in a condition where the preform 20 is placed in the mold 40. FIG. 10 and FIG. 11 show a surface, rather than a cross section, of the preform 20. The mold 40 is used when the winding layer 21 (mainly, the fiber layer 23) of the preform 20 is impregnated with resin, and has an upper mold 41 and a lower mold 42 in this embodiment. The upper mold 41 is superposed on the lower mold 42, so that interior space that conforms the shape of the preform 20 is formed inside the mold 40. The interior space can be evacuated, to form confined space.

Also, the upper mold 41 can be moved relative to the lower mold 42, as indicated by a straight arrow in FIG. 11, thus making it possible to place the preform 20 in the mold 40, and release the preform 20 from the mold 40.

Also, the upper mold 41 is provided with a channel 41a that extends from the outside to the outer periphery (the winding layer 21) of the preform 20 thus placed. By causing the resin composition to flow through the channel 41a, the winding layer 21 (the fiber layer 23) is supplied with and impregnated with the resin composition. Further, the mold 40 is provided with an air flow passage (not shown) used for vacuuming (vacuum deaeration) of the interior space formed in the mold 40.

Also, temperature sensors 43 are installed in the mold 40, for measuring the temperature of the preform 20, so that the temperature of the preform 20 can be obtained, and a temperature controller (not shown) is provided for changing the mold temperature to a desired temperature and keeping the temperature.

The material used for the mold 40 is not particularly limited, but metal is preferably used as usual. Thus, the mold 40 is a so-called metallic mold.

In step S13, the upper mold 41 of the mold 40 is separated from the lower mold 42 so that the mold 40 is placed in an open state, and the preform 20 is mounted on the lower mold 42 of which the upper surface is largely exposed. Then, the upper mold 41 is placed on and fastened to the lower mold 42 and the preform 20 placed in the lower mold 42 so as to cover the preform 20. Then, the mold 40 is subjected to vacuum-deaeration by use of a vacuum pump. The vacuum deaeration is completed before the resin composition is supplied to the winding layer 21 in the next step.

Step S14 of Supplying and Stopping Resin Composition

In step S14 of supplying and stopping the resin composition (which may be referred to as “step S14”), the resin composition that has not been cured is supplied to the winding layer 21 of the preform 20 placed in the mold 40 through the channel 41a, as shown in FIG. 12, and the supply is stopped when the required amount of the resin composition is supplied. In this manner, the winding layer 21 is impregnated with the resin composition.

The time of supply of the resin composition is not particularly limited, but the resin composition is preferably supplied in the following manner. Specifically, the mold 40 is heated, so as to heat the resin contained in the TPP layer 22, and reduce the viscosity of the resin to be lower than that at the time of winding of the TPP 22a, and the resin composition starts being supplied at this time. In this manner, the resin contained in the TPP layer 22 and having the reduced viscosity can be mixed to an increased extent with the resin composition supplied in step S14, and the homogeneity of the resin distribution in the reinforcement layer and the degree of adhesion of the TPP resin with the resin composition used for impregnation are increased, so that peel-off and local reduction in the strength can be avoided. In a more specific example, the temperature of the preform 20 is measured by the temperature sensors 43, for example, and the resin composition for impregnation can be supplied to the winding layer 21 of the preform 20 when the temperature becomes temporarily constant while it is increasing, as in a portion indicated by arrow “B” in FIG. 13, based on the relationship between the time and the temperature, which is obtained in advance as shown in FIG. 13. At this time, it is considered that the resin contained in the TPP has a low vicinity. By grasping the relationship between the temperature of the resin contained in the TPP and the viscosity in advance, it is possible to clearly obtain the time of supply of the resin composition based on measurement results of the temperature sensors 43, and provide a high-pressure tank having stable quality.

As indicated in FIG. 13, the temperature of the resin contained in the TPP increases over time, and reaches a temperature at a position indicated by arrow “C” in FIG. 13. With the temperature thus elevated, curing of the resin composition supplied in step S14 is accelerated; therefore, the time it takes from impregnation to curing can be shortened, and impregnation is efficiently performed. This effect appears more prominently when the low-temperature curing agent as described above is included in the resin contained in the TPP.

The resin composition thus supplied is not particularly limited provided that the resin composition reaches and penetrates the winding layer in a condition where the resin has fluidity, and it is then cured by any method to increase the strength of the fiber layer. For example, the resin may be selected from thermosetting resins that are cured by heat, such as epoxy resin, unsaturated polyester resin, etc. including an amine-based or anhydride curing accelerator, and a rubber-based reinforcing agent. The resin may also be selected from resin compositions having epoxy resin as a base compound, with which a curing agent is mixed for curing of the base compound. While the base compound is mixed with the curing agent and cured, the resin composition as the mixture of the base compound and the curing agent is caused to reach and penetrate the fiber layer, so that the resin is automatically cured.

Step S15 of Releasing Preform from Mold

In step S15 of releasing the preform 20 from the mold 40 (which may be referred to as “step S15”), after it is confirmed in step S14 that the resin contained in the TPP and the resin composition supplied to and impregnating the fiber layer have been cured, the preform 20 impregnated with the resin is released from the mold 40. In this embodiment, the upper mold 41 of the mold 40 is separated from the lower mold 42, to bring the mold 40 into an open state, in which demolding is conducted.

The preform 20 impregnated with the resin is obtained by the manufacturing method including the above steps. A layer made of glass fibers impregnated with resin is further formed as needed, on the preform 20 impregnated with the resin, so that the high-pressure tank 10 is produced.

### 4. Effects, etc.

According to this disclosure, in the case where the process of forming the reinforcement layer includes impregnating the fiber layer formed in the preform with resin through RTM (Resin Transfer Molding), the TPP that has already been impregnated with resin is placed in at least a part of the reinforcement layer, preferably on the inner layer side where resin impregnation is difficult to accomplish, so that the placement of the resin in the layer can be assured in advance. Thus, even when the reinforcement layer needs to have a large thickness, as in the high-pressure tank, for example, the homogeneity of the resin in the reinforcement layer can be enhanced, and the high-pressure tank having high performance can be provided. This also makes it possible to reduce the impregnation time, and improve the productivity.

The resin composition is supplied to the fiber layer formed in the preform, at substantially the same time that the resin contained in the TPP layer is in a low-viscosity state, so that the resin composition thus supplied is more likely to be mixed with the resin contained in the TPP layer, for integration of the resin in both layers, resulting in highly efficient impregnation and improved performance of the high-pressure tank.

The low-temperature curing agent, which is added to the resin contained in the TPP layer, starts curing at an early time while providing high reactivity, so that the resin composition impregnating the fiber layer can be heated from the inner layer side, with heat generated by curing, and efficient impregnation and prompt curing can be both achieved.

According to this disclosure, the winding layer 21 of the preform 20 includes the TPP layer 22, but has the fiber layer 23 formed by winding pre-impregnated fiber bundles 23a; therefore, even when the fluidity is given to the resin of the TPP layer 22 in the mold 40, and the resin moves, to give rise to a change in the winding state of the TPP layer 22, the change in the TPP layer 22 is curbed by the fiber layer 23, and a large change is unlikely to occur in the winding layer in the course of curing of the resin. Consequently, the high-pressure tank having a stable quality can be obtained.

### 5. Other Embodiments

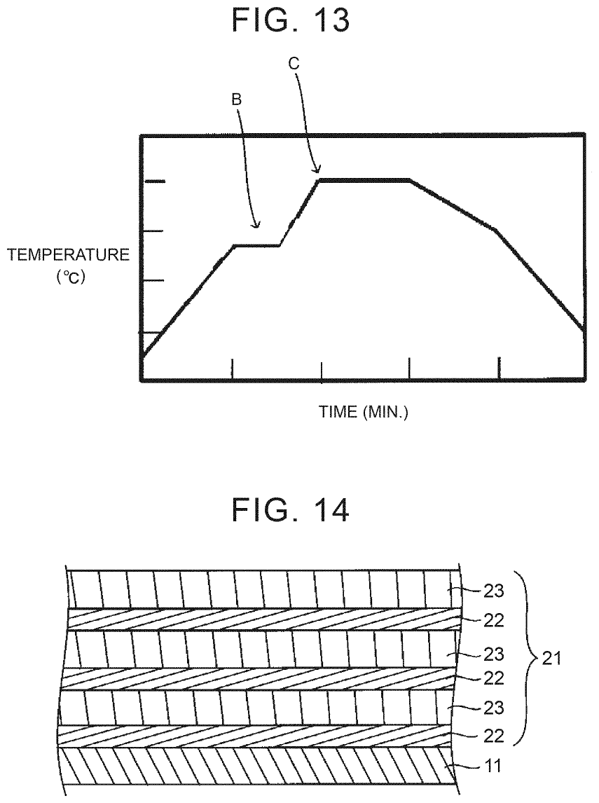

In the method of manufacturing the preform, and the high-pressure tank, the fiber layer 23 is provided on the outer side of the TPP layer 22 that is in contact with the liner 11, as typically illustrated in FIG. 4, FIG. 5, FIG. 6, FIG. 8, and FIG. 9. The disclosure is not limited to this arrangement, but, as other embodiments, the respective layers may be arranged as shown in FIG. 14 and FIG. 15, for example. FIG. 14 is a view as seen from the same viewpoint as FIG. 4. In the embodiment shown in FIG. 14, some fiber layers 23 are placed between TPP layers 22. According to this embodiment, the TPP layer or layers 22 may be placed on the outer layer side. Even with this arrangement of the TPP layers 22, the effects as described above are provided. In this case, however, at least one TPP layer 22 is preferably placed on the inner layer side, and more preferably, one of the TPP layers 22 is in contact with the liner 11.

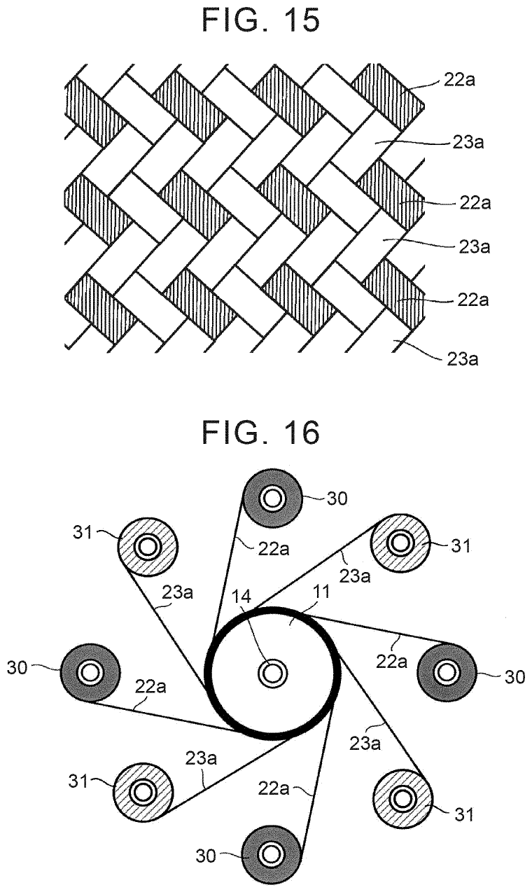

FIG. 15 is a view as seen from the same viewpoint as FIG. 5. In the embodiment shown in FIG. 15, in at least one layer of the winding layer, a mixture of the TPP 22a and the fiber bundles 23a exists in a single layer. Even where the winding layer includes the TPP/fiber layer in which the TPP 22a and fiber bundles 23a are arranged as described above, the above effects are provided. To form the TPP/fiber layer, TPP bobbins 30 and fiber-bundle bobbins 31 may be mixed and used as a plurality of bobbins installed in a multi-supply FW device as shown in FIG. 16, for example.

### 6. Manufacturing Method 2

Here, a method S20 of manufacturing a high-pressure tank according to another embodiment will be described. The method S20 of manufacturing the high-pressure tank is different from the method S10 of manufacturing the high-pressure tank as described above with reference to FIG. 7, in terms of the method of (means for) winding the TPP 22a and winding the fiber bundles 23a performed in step S11 of forming the TPP layer, and step S12 of forming the fiber layer. The manufacturing method S20 is identical with the method S10 of manufacturing the high-pressure tank, with regard to matters other than the means for winding, and thus the other matters will not be described herein. In the following, the method of (means for) winding of the TPP 22a and the fiber bundles 23a in the method S20 of manufacturing the high-pressure tank will be described.

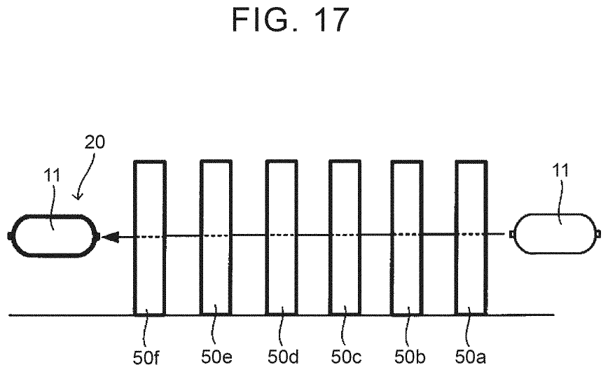

The winding of the TPP 22a in step S11 and winding of the fiber bundles 23a in step S12 in this embodiment will be described with reference to FIG. 17.

In this embodiment, the TPP 22a and the fiber bundles 23a are wound around the liner 11 by the filament winding method, by means of a continuous multi-supply FW apparatus in which two or more multi-supply FW devices are arranged in line. In this embodiment, a multi-supply FW device 50a through a multi-supply FW device 50f are arranged in line, as shown in FIG. 17. Each of the multi-supply FW devices is identical with the multi-supply FW device as described above with reference to FIG. 8 and FIG. 9.

In this embodiment, the two or more multi-supply FW devices are positioned, such that the respective multi-supply FW devices are in charge of different layers for which winding is conducted. Accordingly, as shown in FIG. 17, when the liner 11 moves from the right-hand side to the left-hand side on the paper, and passes through the multi-supply FW devices, windings for all layers are formed, such that the multi-supply FW device 50a forms the first layer, a multi-supply FW device 50b forms the second layer, and a multi-supply FW device the 50c forms the third layer, for example.

Thus, in the continuous multi-supply FW apparatus, a multi-supply FW device for winding the TPP 22a, multi-supply FW device for winding the fiber bundles 23a, or multi-supply FW device for winding a mixture of the TPP 22a and the fiber bundles 23a, depending on the case, can be fixed, and the fibers can be wound with high efficiency, without requiring bobbins to be changed during winding. For example, when the first layer (layer that contacts with the liner 11) is requested to be a layer (TPP layer 22) formed of the TPP 22a, the multi-supply FW device 50a of FIG. 17 may consist solely of the TPP bobbins 30 as shown in FIG. 8. Then, all of the bobbins in the multi-supply FW device 50b through the multi-supply FW device 50f may be provided by the fiber-bundle bobbins 31 as shown in FIG. 9. According to this embodiment, there is no need to change the type of bobbins during winding; thus, the TPP 22a and fiber bundles 23a can be wound with high efficiency.

What is claimed is:

1. A method of manufacturing a high-pressure tank, comprising:
forming a winding layer on an outer periphery of a liner, to prepare a preform; and
placing the preform in a mold, and supplying a resin composition to the winding layer,
wherein formation of the winding layer includes winding of a tow prepreg, and winding of a fiber bundle.

2. The method according to claim 1, wherein the winding layer is formed by winding the tow prepreg, and then winding the fiber bundle on an outer periphery of the tow prepreg.

3. The method according to claim 1, wherein the winding layer is formed, such that at least one of layers that constitute the winding layer is formed by winding a mixture of the tow prepreg and the fiber bundle.

4. The method according to claim 1, wherein the resin composition starts being supplied after a viscosity of a resin contained in the tow prepreg is reduced to be lower than that of the resin during winding.

5. The method according to claim 1, wherein a curing agent that cures a resin contained in the tow prepreg at a temperature lower than a temperature of the mold is added to the resin.

6. The method according to claim 1, wherein winding of the tow prepreg and winding of the fiber bundle are performed with a multi-supply filament winding device, or a continuous multi-supply filament winding apparatus.
